(19) United States
(12) Patent Application Publication
(10) Pub. No.: US 2022/0197807 A1
(43) Pub. Date: Jun. 23, 2022

(54) LATENCY-AWARE PREFETCH BUFFER

(71) Applicant: Ampere Computing LLC, Santa Clara, CA (US)

(72) Inventors: Jonathan Christopher Perry, Santa Clara, CA (US); Stephan Jean Jourdan, Santa Clara, CA (US); Mahesh Jagdish Madhav, Portland, OR (US); Aarti Chandrashekhar, Santa Clara, CA (US)

(21) Appl. No.: 17/125,770

(22) Filed: Dec. 17, 2020

(51) Int. Cl. G06F 12/0862; G06F 12/128; G06F 12/02; G06F 13/16

(52) U.S. Cl. CPC G06F 12/0862; G06F 13/1673; G06F 12/0238; G06F 12/128

(57) ABSTRACT

An apparatus configured to provide latency-aware prefetching, and related systems, methods, and computer-readable media, are disclosed. The apparatus comprises a prefetch buffer comprising at least a first entry, and the first entry comprises a memory operation prefetch request portion storing a first previous memory operation prefetch request. The apparatus further comprises a prefetch buffer replacement circuit, which is configured to select an entry of the prefetch buffer storing a previous memory operation prefetch request for replacement with a subsequent memory operation prefetch request, and to replace the previous memory operation prefetch request in the selected entry with the subsequent memory operation prefetch request.

### BACKGROUND

### I. Field of the Disclosure

The technology of the disclosure relates generally to prefetching, and specifically to a prefetch buffer with latency-aware features.

### II. Background

Microprocessors conventionally perform some amount of cache prefetching. Cache prefetching conventionally involves fetching instructions, data, or both, from a relatively slower-access portion of a memory system associated with the microprocessor (e.g., a main memory) into a relatively faster-access local memory (e.g., an L1 instruction or data cache) in advance of when the instructions or data are demanded by a program executing on the microprocessor. By retrieving instructions or data in this way, the performance of the microprocessor may be increased. The microprocessor does not need to wait on a relatively-slow main memory transaction in order to access the needed instructions or data, but can instead access them in relatively-fast local memory and continue executing.

In order to make the most advantageous use of prefetching, prefetches should be issued in a timely fashion. For example, a prefetch should be issued before a demand load is issued for the same instructions or data; otherwise the prefetch is wasted (because a demand load was already in-flight, and thus the prefetch will not result in retrieving the instructions or data ahead of the demand load). However, it is also possible for a prefetch to be issued too early, in that it results in loading data or instructions into a cache that do not end up being useful, either because they cause other more immediately useful instructions or data to be flushed from the cache (which must then be re-fetched, causing further performance degradation), or because they do not end up being used due to a change in program direction (thus resulting in wasted power). Thus, prefetches should preferably be issued early enough to be useful, but not too early that they cause other performance issues in order to maximize the performance gains related to those prefetches.

The above considerations may apply across various prefetcher implementations, but may be of particular importance when prefetches are serviced by a general-purpose load/store unit in a microprocessor, as opposed to a dedicated prefetching unit, such that prefetches consume processor resources that would otherwise be available for demand loads and stores. Therefore, it would be desirable to design a prefetcher that makes efficient use of the available hardware resources, while generating prefetches in a time window that allows performance gains to be realized.

### SUMMARY OF THE DISCLOSURE

Aspects disclosed in the detailed description include a prefetcher configured to perform latency-aware prefetches, and related apparatuses, systems, methods, and computer-readable media.

In this regard in one aspect, an apparatus is provided that comprises a prefetch buffer comprising at least a first entry, each comprising a memory operation prefetch request portion configured to store a first previous memory operation prefetch request. The apparatus further comprises a prefetch buffer replacement circuit, which is configured to select an entry of the prefetch buffer storing a previous memory operation prefetch request for replacement with a subsequent memory operation prefetch request, and to replace the previous memory operation prefetch request in the selected entry with the subsequent memory operation prefetch request.

In another aspect, an apparatus is provided that comprises means for storing prefetch entries having at least a first entry comprising a memory operation prefetch request portion storing a first previous memory operation prefetch request. The apparatus further comprises means for selecting a prefetch entry for replacement, which is configured to select an entry of the means for storing prefetch entries storing a previous memory operation prefetch request for replacement with a subsequent memory operation prefetch request, and to replace the previous memory operation prefetch request in the selected entry with the subsequent memory operation prefetch request.

In yet another aspect, a method is provided that comprises receiving a first prefetch request. The method further comprises determining a first entry of a prefetch buffer to be replaced by the first prefetch request by a prefetch buffer replacement circuit. The method further comprises writing the first prefetch request into the first entry of the prefetch buffer.

In yet another aspect, a non-transitory computer-readable medium is provided that stores computer executable instructions which, when executed by a processor, cause the processor to receive a first prefetch request. The instructions further cause the processor to determine a first entry of a prefetch buffer to be replaced by the first prefetch request by a prefetch buffer replacement circuit, and to write the first prefetch request into the first entry of the prefetch buffer.

### BRIEF DESCRIPTION OF THE FIGURES

FIG. 1 is a block diagram of an exemplary processor including a prefetcher having latency-aware features;

FIG. 2 is a detailed block diagram of a prefetcher incorporating latency-aware features;

FIG. 3 is a detailed block diagram illustrating a prefetch buffer replacement circuit and associated prefetch buffer which may be adapted to perform latency-aware prefetches;

FIG. 4 is a flowchart illustrating a method of generating and managing latency-aware prefetches; and

FIG. 5 is a block diagram of an exemplary processor-based system including a processor configured to perform latency-aware prefetches.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include a prefetcher configured to perform latency-aware prefetches, and related apparatuses, systems, methods, and computer-readable media.

In this regard in one aspect, an apparatus is provided that comprises a prefetch buffer comprising at least a first entry, each comprising a memory operation prefetch request portion configured to store a first previous memory operation prefetch request. The apparatus further comprises a prefetch buffer replacement circuit, which is configured to select an entry of the prefetch buffer storing a previous memory operation prefetch request for replacement with a subsequent memory operation prefetch request, and to replace the previous memory operation prefetch request in the selected entry with the subsequent memory operation prefetch request.

In another aspect, an apparatus is provided that comprises means for storing prefetch entries having at least a first entry, and the first entry comprises a memory operation prefetch request portion storing a first previous memory operation prefetch request. The apparatus further comprises means for selecting a prefetch entry for replacement, which is configured to select an entry of the means for storing prefetch entries storing a previous memory operation prefetch request for replacement with a subsequent memory operation prefetch request, and to replace the previous memory operation prefetch request in the selected entry with the subsequent memory operation prefetch request.

In yet another aspect, a method is provided that comprises receiving a first prefetch request. The method further comprises determining a first entry of a prefetch buffer to be replaced by the first prefetch request by a prefetch buffer replacement circuit. The method further comprises writing the first prefetch request into the first entry of the prefetch buffer.

In yet another aspect, a non-transitory computer-readable medium is provided that stores computer executable instructions which, when executed by a processor, cause the processor to receive a first prefetch request. The instructions further cause the processor to determine a first entry of a prefetch buffer to be replaced by the first prefetch request by a prefetch buffer replacement circuit, and to write the first prefetch request into the first entry of the prefetch buffer.

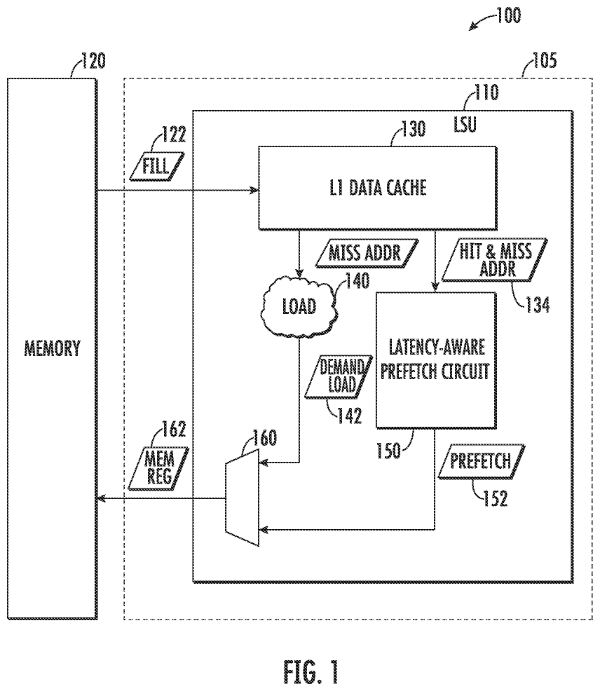

In this regard, FIG. 1 is a block diagram 100 of an exemplary processor 105 configured to perform latency-aware prefetches from a memory system 120. The processor 105 may include a load/store unit 110 for performing memory operations (including latency-aware prefetches), which includes a cache such as an L1 data cache 130, a load generation circuit 140, a latency-aware prefetch circuit 150, and a memory operation selector circuit 160. The load/store unit 110 dispatches memory requests (such as memory request 162) to the memory system 120, and receives fill responses (such as fill response 122) from the memory system, which may be written into a cache such as the L1 data cache 130.

The load/store unit 110 of the processor 105 is configured to generate both demand loads (i.e., a load of specific data that the processor has requested) and prefetches (i.e., a speculative load of data that the processor may need in the future). Demand loads (such as demand load 142) are generated by the load generation circuit 140 in response to a corresponding miss on a lookup to the L1 data cache 130 for data at a miss address 132. The L1 data cache 130 provides the miss address 132 to the load generation circuit 140, and in response the load generation circuit 140 forms the demand load 142. Latency-aware prefetches (such as prefetch request 152) are generated by the latency-aware prefetch circuit 150. The latency-aware prefetch circuit 150 receives hit and miss address information 134 from the L1 data cache 130, and uses this information to predict what data may be needed next by the processor 105 and generate prefetch requests based on the prediction.

The load/store unit 110 of processor 105 is a shared load/store unit (i.e., the same load/store unit services both demand loads and prefetch requests). As such, the load/store unit 110 includes a memory operation selector circuit 160 configured to select between a demand load (such as demand load 142) and a prefetch request (such as prefetch request 152) for dispatch to the memory system 120. Further, the processor 105 may be configured to prioritize demand loads over prefetches, since performing prefetches when demand loads are waiting may cause undesirable performance degradation (e.g., due to the processor 105 to stall while waiting on the data requested by the demand load). Prioritizing demand loads in this way may reduce the likelihood that the processor 105 will need to stall while waiting on data. However, prioritizing demand loads may also lead to the situation where a previously-generated prefetch request has become “stale” (i.e., the data represented by the prefetch request may no longer be needed, or may already have been retrieved by an intervening demand load).

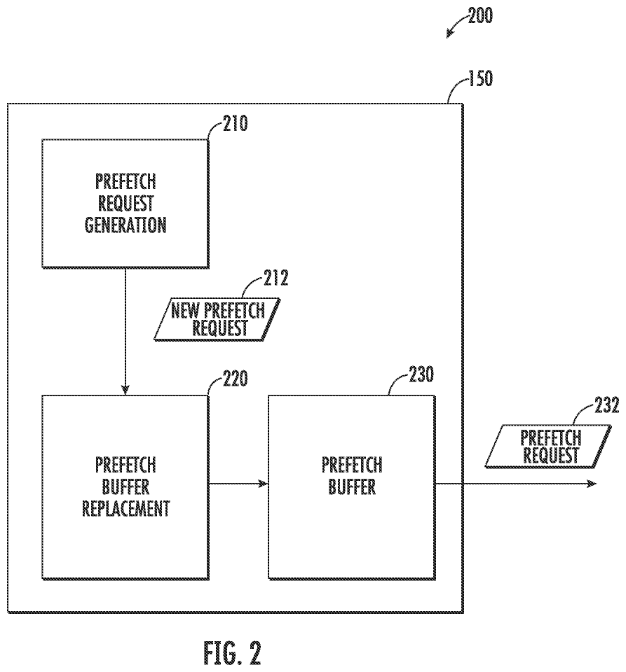

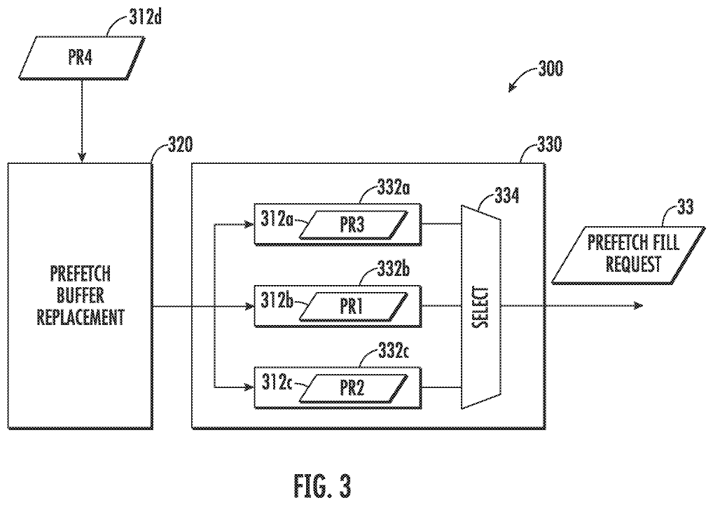

To address this, as will be discussed in greater detail below with respect to FIGS. 2 and 3, the latency-aware prefetch circuit 150 in the processor 105 in FIG. 1 may be configured to continuously generate new prefetch requests, and may replace previously-generated prefetch requests which have not yet been serviced with relatively newer prefetch requests, which may be more likely to retrieve useful data. The latency-aware prefetch circuit 150 may generate new prefetches based on a stride value, a predicted next address, as examples, or any other method of determining an address for prefetch known to those having skill in the art. Thus, in operation, the latency-aware prefetch circuit 150 may update existing prefetch requests with newly-generated prefetch requests, such that the prefetch request 152 that is presented to the memory operation selector circuit 160 may change from cycle to cycle. This may result in the prefetch request 152 available for dispatch by the memory operation selector circuit 160 to the memory system 120 being more “up to date” as compared to a system where previous prefetch requests are not replaced, which may be particularly important in a system where “gaps” between demand loads are unpredictable, and thus it is not guaranteed that any particular prefetch request will be able to be dispatched in a timely manner.

To further illustrate the above-described updates to existing prefetch requests, FIG. 2 is a detailed block diagram of a system 200 including an example of the latency-aware prefetch circuit 150 in FIG. 1. The latency-aware prefetch circuit 150 includes a prefetch request generation circuit 210, configured to form a new prefetch request 212. As discussed above with reference to FIG. 1, the prefetch request generation circuit 210 may receive hit and miss address information 134 from a cache memory, and may use the hit and miss address information 134 in determining how to form the new prefetch request 212. Determining how to form the new prefetch request 212 may be done in accordance with conventional techniques—for example, the latency-aware prefetch circuit 150 may examine the hit and miss address information 134 to determine a “stride” for the prefetches (i.e., a distance between likely subsequent load addresses), and may generate a prefetch having an address some distance ahead of the most recent demand miss based on the determined stride. Additionally, the system 200 may determine that a multiple of the basic stride value may be the optimal prefetch distance, and may generate one or more prefetches based on the stride and a multiple of the stride. For example, if the system 200 supports having two prefetch requests in flight, the system 200 may generate a first prefetch request for an address one stride value ahead of a current demand load and a second prefetch request for an address at two times the stride value ahead of the current demand load. This may avoid the situation where a prefetch “hole” develops (i.e., an address that is between a current demand load and a first pending prefetch request).

The new prefetch request 212 is provided to a prefetch buffer replacement circuit 220, which will select an entry of a prefetch buffer 230 to be replaced by the new prefetch request 212. In one aspect where the prefetch buffer 230 includes only a single entry, the prefetch buffer replacement circuit 220 may simply replace the contents of the single entry with the new prefetch request 212. In other aspects where the prefetch buffer 230 includes two or more entries, the selection of which entry of the prefetch buffer 230 to replace may be performed according to conventional replacement algorithms—for example, the prefetch buffer replacement circuit 220 may examine the relative age of the entries, and may select the oldest valid entry for replacement by the new prefetch request 212. In such an implementation, the prefetch buffer may be configured as a first-in-first-out (FIFO) buffer, and as such may be implemented as a circular buffer with a pointer that tracks the current “oldest” entry and wraps around, as will be readily understood by those having skill in the art.

The prefetch buffer 230 may store one or more entries, each entry containing a prefetch request which may be replaced as described above with respect to the prefetch buffer replacement circuit 220, and may select an entry of the one or more entries to be provided to the memory operation selector circuit 160 as prefetch request 232. Further, in aspects where the prefetch buffer 230 includes two or more entries, the prefetch buffer 230 may employ a selection algorithm such as “first-in, first-out” (FIFO) to determine which of the two or more entries to provide to the memory operation selector circuit 160 as a prefetch request 232.

Those having skill in the art will appreciate that the choice of the specific replacement algorithm and selection algorithm described above is a matter of design choice, and other known or developed algorithms may be used to perform either of these functions in the prefetch buffer replacement circuit 220 and the prefetch buffer 230 without departing from the teachings of the present disclosure. For example, in addition to the FIFO algorithm described above, in other aspects a “last-in, first-out” (LIFO), ping-pong, round robin, random, or duplicate address coalescing algorithms may be employed based on the parameters of a particular system, expected workload, and other factors which will be apparent to those having skill in the art. Further, although the new prefetch request 212 is illustrated as being provided to the prefetch buffer replacement circuit 220, which then chooses an entry in the prefetch buffer 230 to replace and provides the new prefetch request 212 to the prefetch buffer, those having skill in the art will recognize that the new prefetch request 212 could be provided directly to the prefetch buffer 230, while the prefetch buffer replacement circuit 220 would still control which of the entries of the prefetch buffer 230 was replaced with the new prefetch request 212.

To further illustrate the case where a prefetch buffer includes multiple entries, FIG. 3 is a detailed block diagram 300 illustrating a prefetch buffer replacement circuit 320 and an associated prefetch buffer 330, which may be adapted to perform latency-aware prefetches. As a non-limiting example, the prefetch buffer replacement circuit 320 may be included in the processor 105 in FIG. 1 as the latency-aware prefetch circuit 150. With reference to FIG. 3, the prefetch buffer 330 includes a plurality of entries, such as entries 332a-332c, and a selection circuit 334. The prefetch buffer replacement circuit 320 is coupled to the plurality of entries 332a-332c.

In operation, the prefetch buffer replacement circuit 320 receives a newly-formed prefetch request, such as new prefetch request 312d, from a prefetch request generation circuit as discussed above. The prefetch buffer replacement circuit 320 then evaluates the plurality of entries 332a-332c of the prefetch buffer 330 based on a replacement policy, which may be the FIFO replacement policy as discussed above. For example, entry 332b may contain a first previous prefetch request 312a comprising prefetch request PR1, entry 332c may contain second previous prefetch request 312b comprising prefetch request PR2, and entry 332a may contain a third previous prefetch request 312c comprising prefetch request PR3, where the prefetch request PR1 is older than the prefetch request PR2, and the prefetch request PR2 is older than the prefetch request PR3. The prefetch buffer replacement circuit 320 will evaluate the prefetch requests PR1, PR2, and PR3, determine that the prefetch request PR1 in entry 332b is the oldest existing prefetch request, and will replace the prefetch request PR1 in entry 332b with the new prefetch request 312d containing prefetch request PR4. The prefetch buffer 330 may track the relative age of entries 332a-332c by any conventional method of tracking age, such as by implementing the entries 332a-332c as a circular buffer with a pointer indicating the oldest entry, by storing and updating age information in entry, or by other methods that will be apparent to those having skill in the art (such as implementing a full crossbar-type comparison of the ages of all entries, or by association of an expiration time with each entry so that entries beyond a certain age are replaced without being used).

Similarly, the selection circuit 334 may also employ a selection policy which matches the replacement policy (e.g., if a FIFO replacement policy is used, the selection policy will select an entry for dispatch according to the same FIFO algorithm as used in the replacement policy, such that the entry selected for dispatch would also be the next entry selected for replacement under the replacement policy) as discussed above when selecting one of the plurality of entries 332a-332c for dispatch as a prefetch fill request 332. To continue the example discussed above using a FIFO selection algorithm, once the prefetch buffer replacement circuit 320 has replaced the prefetch request PR1 in entry 332b with the new prefetch request 312d containing prefetch request PR4, entry 332c containing prefetch request PR2 is now the oldest prefetch request stored in entries 332a-332c. Thus, when it is possible to submit a new prefetch fill request, the selection circuit 334 may select the prefetch request PR2 in entry 332c for dispatch to an associated memory system as prefetch fill request 332.

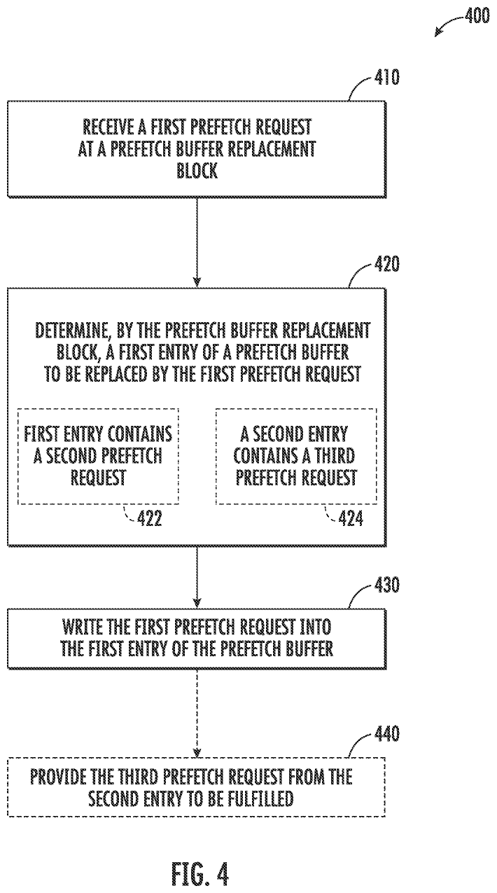

FIG. 4 is a flowchart illustrating a process 400 of generating and managing latency-aware prefetches, as may be performed by the systems illustrated in the preceding FIGS. 1-3, for example. The process 400 begins in block 410, where a first prefetch request is received at a prefetch buffer replacement circuit, such as new prefetch request 312d being received at the prefetch buffer replacement circuit 320 of FIG. 3.

The process 400 continues in block 420, where the prefetch buffer replacement circuit determines a first entry of a prefetch buffer to be replaced by the first prefetch request. The prefetch buffer may include a second prefetch request in the first entry, and a third prefetch request in the second entry. For example, with respect to FIG. 3, the prefetch buffer replacement circuit 320 may determine that prefetch request 312b containing prefetch request PR1 in entry 332b is the oldest, and may determine that it should be replaced with the new prefetch request 312d containing prefetch request PR4.

The process 400 continues in block 430, where the prefetch buffer replacement circuit writes the first prefetch request into the first entry of the prefetch buffer. For example, with respect to FIG. 3, the new prefetch request 312d containing prefetch request PR4 is written into entry 332b, and replaces prefetch request 312b containing prefetch request PR1.

The process 400 may further continue in block 440, where the third prefetch request from the second entry is provided to a memory system to be fulfilled as a prefetch fill request. For example, with respect to FIG. 3, prefetch request 312c containing prefetch request PR2 from entry 332c may now be the oldest prefetch request in the prefetch buffer 330, and as such, it may be selected by the selection circuit 334 for dispatch to an associated memory system as prefetch fill request 332.

Those having skill in the art will recognize that the choice of specific cache types in the present aspect are merely for purposes of illustration, and not by way of limitation, and the teachings of the present disclosure may be applied to other prefetches. For example, prefetch requests may conventionally be applied in the context of loads, but in other contexts it may be beneficial to perform prefetches of data where the processor expects to perform a store to that particular address, and thus, prefetching that address into the cache may allow the store to take place more efficiently. Thus, the prefetch requests described above may be applied to all types of memory operations, and may be referred to as memory operation prefetch requests. Additionally, specific functions have been discussed in the context of specific hardware blocks, but the assignment of those functions to those blocks is merely exemplary, and the functions discussed may be incorporated into other hardware blocks without departing from the teachings of the present disclosure.

The exemplary processor that can perform latency-aware prefetching according to aspects disclosed herein may be provided in or integrated into any processor-based device. Examples, without limitation, include a server, a computer, a portable computer, a desktop computer, a mobile computing device, a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a wearable computing device (e.g., a smart watch, a health or fitness tracker, eyewear, etc.), a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

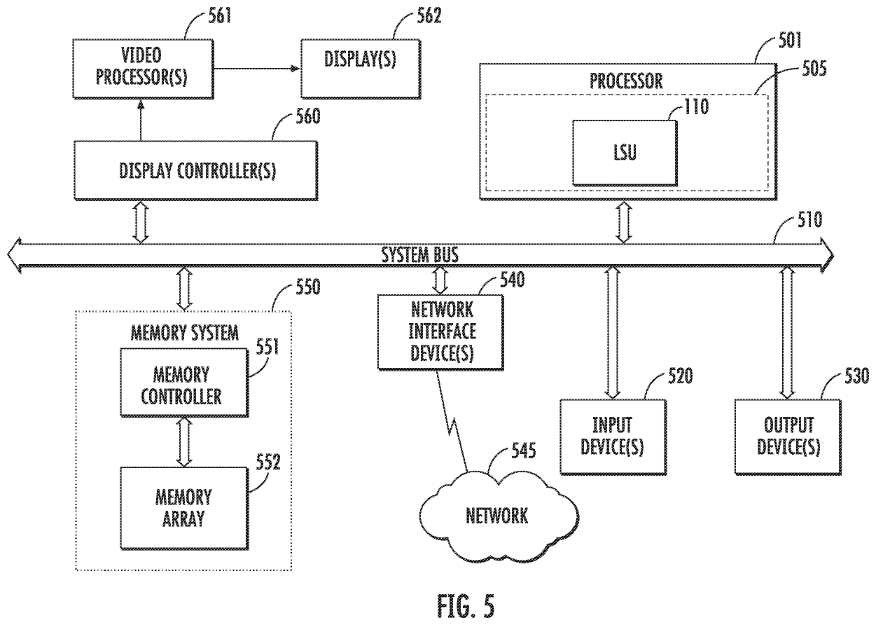

In this regard, FIG. 5 illustrates an example of a processor-based system 500 that can perform latency-aware prefetching as illustrated and described with respect to FIGS. 1-4. In this example, the processor-based system 500 includes a processor 501 having one or more central processing units (CPUs) 505, each including one or more processor cores, and which may correspond to the processor 105 of FIG. 1, and as such may include the load/store unit 110, which may be configured to perform latency-aware prefetching as illustrated and described with respect to FIGS. 1-4. The CPU(s) 505 may be a master device. The CPU(s) 505 is coupled to a system bus 510 and can intercouple master and slave devices included in the processor-based system 500. As is well known, the CPU(s) 505 communicates with these other devices by exchanging address, control, and data information over the system bus 510. For example, the CPU(s) 505 can communicate bus transaction requests to a memory controller 551 as an example of a slave device. Although not illustrated in FIG. 5, multiple system buses 510 could be provided, wherein each system bus 510 constitutes a different fabric.

Other master and slave devices can be connected to the system bus 510. As illustrated in FIG. 5, these devices can include a memory system 550, one or more input devices 520, one or more output devices 530, one or more network interface devices 540, and one or more display controllers 560, as examples. The input device(s) 530 can include any type of input device, including, but not limited to, input keys, switches, voice processors, etc. The output device(s) 520 can include any type of output device, including, but not limited to, audio, video, other visual indicators, etc. The network interface device(s) 540 can be any devices configured to allow exchange of data to and from a network 545. The network 545 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 540 can be configured to support any type of communications protocol desired. The memory system 550 can include the memory controller 551 coupled to one or more memory units 552.

The CPU(s) 505 may also be configured to access the display controller(s) 560 over the system bus 510 to control information sent to one or more displays 562. The display controller(s) 560 sends information to the display(s) 562 to be displayed via one or more video processors 561, which process the information to be displayed into a format suitable for the display(s) 562. The display(s) 562 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. An apparatus, comprising:
a prefetch buffer comprising a plurality of entries, each comprising a memory operation prefetch request portion configured to store a previous memory operation prefetch request, and
a prefetch buffer replacement circuit;
the prefetch buffer replacement circuit configured to select one of the plurality of entries of the prefetch buffer storing a previous memory operation prefetch request for replacement with a subsequent memory operation prefetch request, and to replace the previous memory operation prefetch request in the selected one of the plurality of entries with the subsequent memory operation prefetch request based on a replacement policy comprising one of a “last-in, first-out” (LIFO), ping-pong, round robin, random, and duplicate address coalescing policy.

2. (canceled)

3. (canceled)

4. The apparatus of claim 1, wherein the prefetch buffer comprises a circular buffer.

5. The apparatus of claim 1, wherein the prefetch buffer is configured to select an entry of the prefetch buffer storing a previous memory operation prefetch request to be provided as a prefetch fill request based on a selection policy, and to generate a prefetch fill request based on the previous memory operation prefetch request stored in the selected entry.

6. The apparatus of claim 5, wherein
the prefetch buffer replacement circuit is configured to select the entry of the prefetch buffer storing the previous memory operation prefetch request for replacement with the subsequent memory operation prefetch request based on a replacement policy; and
the selection policy and the replacement policy are based on the same algorithm.

7. The apparatus of claim 5, wherein the prefetch buffer is further configured to provide the prefetch fill request to a memory system.

8. The apparatus of claim 1, further comprising a prefetch request generation unit configured to generate memory operation prefetch requests, comprising the first previous memory operation prefetch request and the subsequent memory operation prefetch request.

9. The apparatus of claim 8, wherein the prefetch request generation unit is further configured to generate a plurality of memory operation prefetch requests based on a stride value.

10. The apparatus of claim 9, wherein the prefetch request generation unit is further configured to generate the plurality of memory operation prefetch requests based on a stride value by generating a first memory operation prefetch request based on the stride value and a second memory operation prefetch request based on an integer multiple of the stride value.

11. The apparatus of claim 1 integrated into an integrated circuit (IC).

12. The apparatus of claim 10 further integrated into a device selected from the group consisting of: a server, a computer, a portable computer, a desktop computer, a mobile computing device, a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a wearable computing device (e.g., a smart watch, a health or fitness tracker, eyewear, etc.), a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

13. An apparatus, comprising:
means for storing prefetch entries having a plurality of entries each comprising a memory operation prefetch request portion storing a previous memory operation prefetch request, and
means for selecting a prefetch entry for replacement;
the means for selecting a prefetch entry for replacement configured select one of the plurality of entries of the means for storing prefetch entries storing a previous memory operation prefetch request for replacement with a subsequent memory operation prefetch request, and to replace the previous memory operation prefetch request in the selected one of the plurality of entries with the subsequent memory operation prefetch request based on a replacement policy comprising one of a “last-in, first-out” (LIFO), ping-pong, round robin, random, and duplicate address coalescing policy.

14. (canceled)

15. A method, comprising:
receiving a first prefetch request;
determining one of a plurality of entries of a prefetch buffer in which a previous memory operation prefetch request is to be replaced by the first prefetch request by a prefetch buffer replacement circuit based on a replacement policy comprising one of a “last-in, first-out” (LIFO), ping-pong, round robin, random, and duplicate address coalescing policy; and
writing the first prefetch request into the determined one of the plurality of entries of the prefetch buffer.

16. (canceled)

17. (canceled)

18. The method of claim 15, further comprising selecting an entry of the prefetch buffer storing a memory operation prefetch request to be provided as a prefetch fill request based on a selection policy, the selection policy and the replacement policy based on the same algorithm.

19. A non-transitory computer-readable medium having stored thereon computer executable instructions which, when executed by a processor, cause the processor to:
receive a first prefetch request;
determine one of a plurality of entries of a prefetch buffer in which a previous memory operation prefetch request is to be replaced by the first prefetch request by a prefetch buffer replacement circuit based on a replacement policy comprising one of a “last-in, first-out” (LIFO), ping-pong, round robin, random, and duplicate address coalescing policy; and
write the first prefetch request into the determined one of the plurality of entries of the prefetch buffer.

20. The non-transitory computer-readable medium of claim 19, wherein:
a first entry of the plurality of entries of the prefetch buffer comprises a second prefetch request replaced with the first prefetch request;
the prefetch buffer comprises a second entry of the plurality of entries containing a third prefetch request, and
the computer executable instructions which, when executed by the processor further cause the processor to determine to replace the first entry instead of the second entry based on the replacement policy.

21. The apparatus of claim 1, wherein each entry of the plurality of entries further comprises an indication of an expiration time of the first previous memory operation prefetch request in the memory operation prefetch request portion.

22. The apparatus of claim 1, further comprising a prefetch request generation circuit configured to:
receive hit and miss address information from a cache memory;
determine a stride comprising a distance between memory load addresses; and
generate a new memory operation prefetch request based on the received hit and miss address information and a multiple of the stride.
